(19) United States
(12) Patent Application Publication
(10) Pub. No.: US 2007/0005746 A1
(43) Pub. Date: Jan. 4, 2007

(54) Enhanced network discovery service

(76) Inventors: Bryan Y. Roe, Camas, WA (US); Ylian Saint-Hilaire, Hillsboro, OR (US); Nelson F. Kidd, Camas, WA (US); Pronay Dutta, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/173,958

(22) Filed: Jun. 30, 2005

(51) Int. Cl. G06F 15/173

(52) U.S. Cl. 709/223

(57) ABSTRACT

A method and apparatus for an enhanced network discovery service. An embodiment of a method includes identifying one or more network devices on a network and storing state information regarding the network devices. Upon receiving a query regarding network devices or services of network devices that meet a criterion, the state information is searched to identify network devices that meet the criterion.

### FIELD

An embodiment of the invention relates to computer networks in general, and more specifically to an enhanced network discovery service.

### BACKGROUND

Multiple computer network devices, such as UPnP™ (Universal Plug and Play) devices may operate in a system. Controllers, including UPnP control points, may wish to discover the network devices, such as in situations in which the controller requires a particular service from a network device. A controller may have limited ability to discover the needed device. For example, conventional UPnP discovery methods are very basic and inefficient. A control point generally may only query for devices based on limited categories, such as device type, service type, or device ID.

However, a controller may only have interest in devices with certain properties, such as UPnP devices that are in a certain state. Devices that are not in the desired state may not be useful to the controller. In conventional operations, the discovery of network devices that are in a particular state is a cumbersome process that involves a large amount of network traffic. To obtain the needed information, a controller may need to interrogate each device on the network.

Further, once network devices have been found, the network devices may in some instances drop off the network without any warning to a controller. For example, if a mobile wireless device strays outside range of the network, the network device may not be immediately aware that it is no longer in the network and thus may not provide a warning of the loss of service. A controller may be required to continue interrogation efforts to determine whether discovered devices have subsequently left the network, changed state, or are otherwise not available to the controller. Thus, a controller may be required to devote an inordinate deal of time and effort to discovering and maintaining information regarding network devices that can provide needed services to the controller.

### BRIEF DESCRIPTION OF THE DRAWINGS

The invention may be best understood by referring to the following description and accompanying drawings that are used to illustrate embodiments of the invention. In the drawings:

FIG. 1 is an illustration of an embodiment of a network including an enhanced network device discovery service;

FIG. 2 is an illustration of a network discovery service;

FIG. 3 illustrates an embodiment of discovery processes for UPnP devices;

FIG. 4 is a flowchart to illustrate an embodiment of a process for maintaining state information for controllable devices on a network; and

FIG. 5 is a flowchart to illustrate an embodiment of a process for discovering a network device using a network discovery service.

### DETAILED DESCRIPTION

A method and apparatus are described for an enhanced network discovery service.

In one embodiment of the invention, a network includes an enhanced discovery service for the discovery of network devices. In one embodiment, a discovery service enables a controller to discover network-devices that are in a particular state.

In one example, a controller is a UPnP controller and a network device is a UPnP device. In this example, the controller utilizes a discovery service to discover needed UPnP devices on the network, such as devices that provide a certain service.

In one embodiment of the invention, a network discovery service identifies each network device on a network and subscribes to all of the events of each of the devices. The network discovery service then maintains one or more values for each network device to reflect the current state of the network device. In one embodiment, the network discovery service operates by discovering all network devices on the network. In another embodiment, each network device will register with the network service upon entering the network. The registration of network devices to the network discovery service may be particularly useful in circumstances in which one or more network devices reside in different network segments than the discovery service. In other embodiments, a combination of discovery and registration processes or similar processes may be used.

In one embodiment, a control point may formulate a query to a network discovery service that asks for any devices or services that meet specific search criteria. The search criteria may be any factors regarding network devices or services, including state variables of certain values or a device with certain characteristics and capabilities. Upon completing a search for devices or services that meet the characteristics, the discovery service returns an XML document that contains pointers to all of the devices and services that meet the criteria. As a result, a control point receives a filtered list of devices meeting certain criteria with minimal effort and network traffic.

In one embodiment of the invention, a network discovery service utilizes state information regarding network devices on the network to support a query engine. The query engine will provide responses to queries regarding the availability of network devices or service provided by network devices. For example, a controller may formulate a query inquiring about network devices that meet certain criteria, and then direct the query to the network discovery service. The network discovery service directs the query to the query service to determine what network devices meet the criteria. The network discovery service then may provide a response to the controller that identifies the network devices that meet the provided criteria.

In one possible example, a network discovery service may identify all UPnP devices on a network. The devices that are discovered may include a particular UPnP media renderer. The discovery service subscribes to all events of the devices, including the media renderer, and maintains a state for each device. Through this process, the network discovery service determines that the UPnP media renderer currently supports MPEG2 (Moving Pictures Experts Group 2) video, a particular video data standard that is optimized for broadcast quality video. Following this, a UPnP control point formulates an inquiry to the network discovery service requesting any devices that meet certain criteria, with the criteria including any media renderer that supports certain standards, including MPEG2. The network discovery service utilizes a query engine to search the current states of network devices and identify the media renderer as a candidate for the control point. The network discovery system then provides a response to the control point, the response including information regarding the media renderer.

In an embodiment of the invention, because a network discovery service subscribes to events of network devices and maintains the state of each device, the service also may address issues regarding loss of network devices. In certain cases, such as in a wireless environment, a network device may drop off a network abruptly. For instance, the signal connection with the network might be lost. Because of the unexpected signal loss, the network device will not have an opportunity to provide an advertisement of the exit from the network (what is referred to as a “bye-bye” message from a UPnP device). In conventional operations, a UPnP control point may not become aware of the loss of a network device until the control point attempts to contact the network device. However, the network discovery service may become aware of the loss of a network device and can provide notice of this. In one embodiment, the network discovery service will periodically request renewal of subscriptions to events of network devices. If the network discovery service does not receive a response the service may determine that the network device has left the network or has otherwise become unavailable. Upon determining that a network device has become unavailable, the network discovery service can provide a proxy bye-bye message on behalf of the device, thereby informing the control point of the loss of the device.

Embodiments of the invention may be implemented using various technologies. In one embodiment of the invention, a query to a network discovery service may include an XML XPath query, a highly extensible and flexible messaging element. XPath is a language that describes a way to locate and process items in Extensible Markup Language (XML) documents by using an addressing syntax based on a path through the document's logical structure or hierarchy.

In one embodiment of the invention, a network discovery service may utilize certain directory technologies for the purpose of storing and maintaining state data regarding network devices and services. Relevant technologies may include Active Directory, LDAP (Lightweight Directory Access Protocol), and other directory services. The Active Directory technology of Microsoft Corporation may be utilized to enable construction of a custom, centralized resource management infrastructure. The Active Directory may utilize the LDAP protocol to communicate among directory-enabled computers. LDAP defines an process to make use of X.500 directories, with X.500 designating the set of ITU-T (the telecommunications standards sector of the International Telecommunications Union) standards for electronic directory services. LDAP is defined by a number of RFC standards of the Internet Engineering Task Force (IETF), which may include RFC 2251: Lightweight Directory Access Protocol (v3), December 1997.

In one embodiment of the invention, a network discovery service may itself be discovered by a controller through DNS/DHCP (Domain Name System/Dynamic Host Configuration Protocol) or through UPnP SSDP (simple service discovery protocol). DNS is a system to store information about host names and domain names in a distributed database on a networks, and DHCP provides a protocol to dynamically allocate IP addresses to computers on a local area network

Universal plug-and-play (UPnP) is a set of computer network protocols that are promulgated by the UPnP Forum. (UPnP Device Architecture, version 1.0, Jun. 13, 2000; in addition, see Basic: 1.0, Device Definition Version 1.0 For UPnP Version 1.0, Feb. 12, 2002, and definitions for specific types of UPnP devices). A UPnP device is a device that is substantially compliant with UPnP or a derivative thereof, which are hereinafter referred to simply as UPnP. UPnP is intended to enable devices to connect seamlessly and to simplify the implementation of networks. UPnP enables data communication between any two devices under the command of any control device on the network. A UPnP control point is a controller that is capable of discovering and controlling other UPnP devices.

Embodiments of the invention may be implemented in many different types of network environments. In one example, an embodiment of the invention may be implemented in a consumer environment or other similar environment in which costs and resources are required to be minimal. The ability of a control point to query for a filtered set of devices may allow the control point to be more compact in implementation and more useful in a limited environment. In this setting, accurate information regarding devices and their current states may be provided without additional resources.

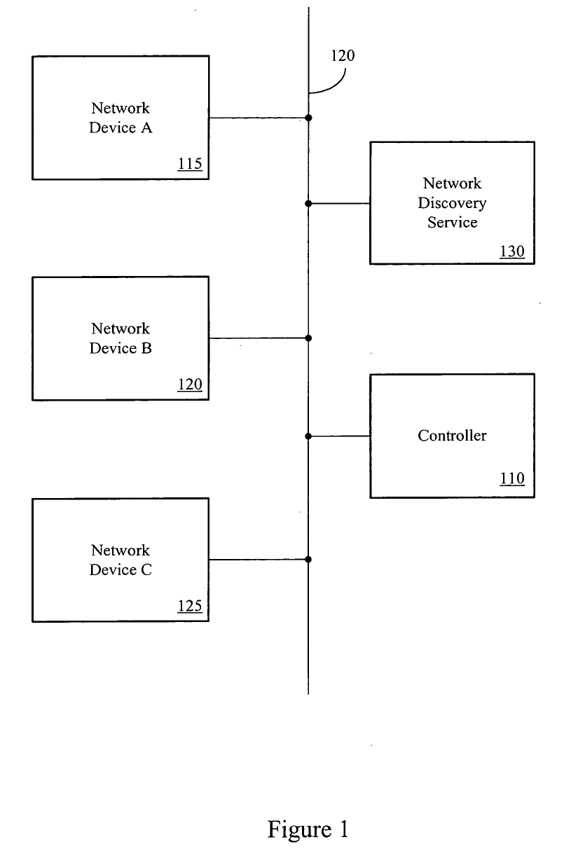

FIG. 1 is an illustration of an embodiment of a network including an enhanced network device discovery service. In this illustration, a network 105 includes a controller 110, such as a UPnP control point, and one or more network devices, which may include UPnP network devices. The network devices are shown as network device A 115, network device B 120, and network device C 125. A simple network is provided for purposes of illustration, but any type of network arrangement may utilize embodiments of the invention.

In one embodiment, a network discovery service 130 is coupled with the network. The network discovery service 130 may be implemented as software, hardware, or as a combination of both. The network discovery service 130 identifies the network devices on the network, including network device A 115, network device B 120, and network device C 125. In one embodiment, the network discovery service 130 discovers all network devices that are connected to the network 105. In another embodiment, network devices register with the network discovery service 130 upon entering the network. The network discovery service 130 further subscribes to any events of the network devices. The network discovery service 130 maintains data regarding the network devices, the data to include the identity of each device, the services provided by each device, and the status of each device. As the discovery service 130 receives updates regarding the network devices, the data is updated.

The controller 110 may require a particular type of service from a network device. In order to determine which network devices or devices may supply the service, the controller 110 formulates a query and transfers the query to the discovery service 130. The network discovery service 130 receives the query and performs a search of the data maintained by the service. Upon completing the search, the network discovery service 130 transfers a response to the controller 110. The response may include pointers to devices that meet the criteria provided in the query. For example, if the query requests a search for a network device providing a particular service and the service is provided by network device A 115, the network discovery service 130 will identify the device and send the controller 110 a response that includes a pointer to device A 115. The controller 110 may then institute a relationship with network device A 115 to obtain a required service. In this manner, the controller 110 is able to identify all network devices that meet the requirements of the controller through a single inquiry without being required to interrogate each of the devices.

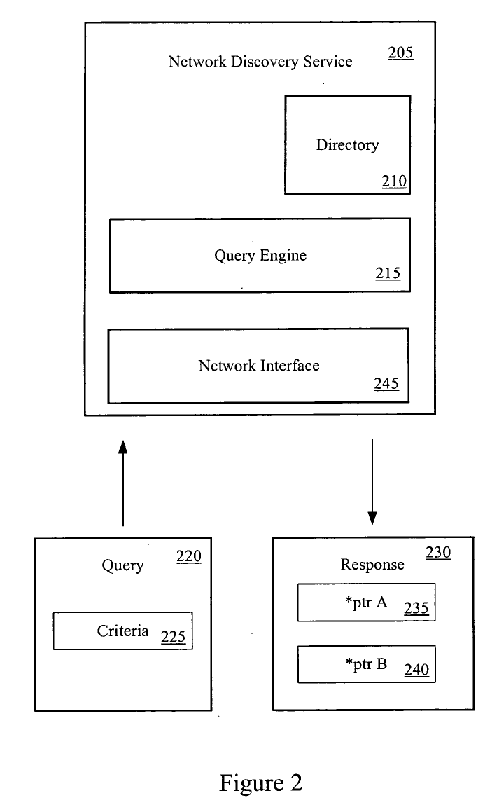

FIG. 2 is an illustration an embodiment of a network discovery service. In this illustration, a network discovery service 205 may provide services for discovering UPnP devices on a network. The network discovery service 205 includes a directory 210 to maintain data regarding the states of devices on the network. The directory 210 may be organized according to a directory standard, including, but not limited to, LDAP and Active Directory. In one embodiment of the invention, the network discovery service 205 obtains the data stored in the directory by interrogating all network devices and subscribing to all of the events of each network device. In another embodiment, the network devices may register with the network discovery service 205. The network discovery service may include a network interface 245 to communicate with other agents on the network.

The network discovery service 205 further includes a query engine 215 to respond to queries regarding network devices and services provided by such devices. The network discovery service 205 may receive a query 220 regarding network devices or services. The query 220 may be received from a controller, such as a UPnP control point. In one example, the query 220 may in the form of an XML XPath query. The query may include various criteria 225 to describe needed devices or services. The query 220 is directed to the query engine 215 of the network discovery service 205. The query engine 215 extracts the criteria elements from the query 220 and searches the directory 210 for matching devices and services. Upon determining what devices and services match the requirements of the query 220, the query engine 215 will formulate a response 230, which may be in the form of an XML document. The response 230 may contain pointers to matching network devices, such a pointer to a network device A 235 and a pointer to a network device B 240. The control point then may contact one or more identified devices to obtain needed services.

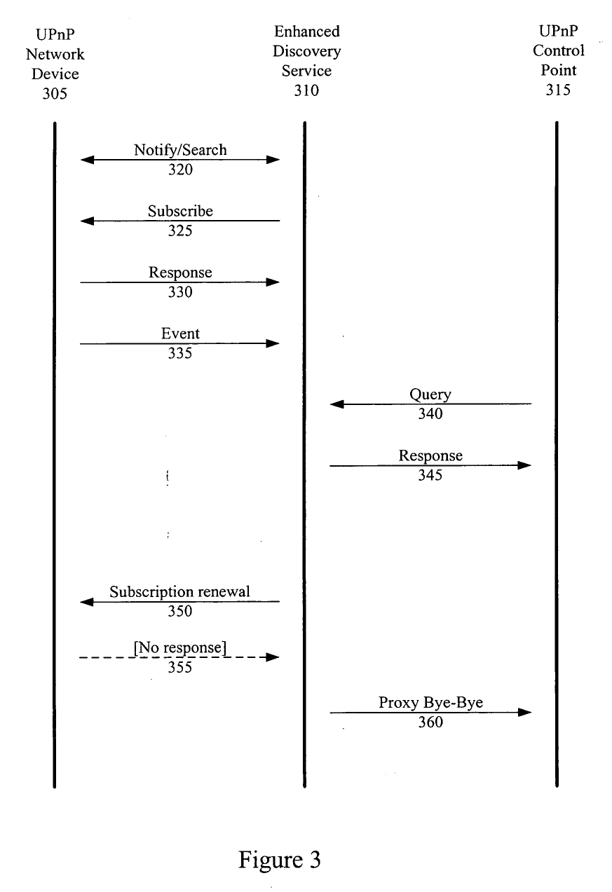

FIG. 3 illustrates an embodiment of discovery processes for UPnP devices. In this illustration, a UPnP control point 315 utilizes an enhanced discovery service 310 to discover a UPnP network device 305 or service provided by such device. The UPnP network device 305 is identified by the enhanced discovery service 310 either by the service searching for devices or by the device notifying the service of its presence on the network 320. The enhanced discovery service 310 subscribes to each event of the UPnP device 325, thereby being a recipient of any relevant events. The UPnP device 305 provides a response 330 to the subscription request. The UPnP network device 305 then may transmit an event 335 to the enhanced discovery service 310 with regard to a subscribed service.

The UPnP control point 315 may send a query 340 to the UPnP discovery service 310. The query 340 may include certain criteria describing a network device or service provided by a network device that the control point 315 wishes to locate. The enhanced discovery service 310 examines the criteria and determines whether the service has identified any network devices meeting the stated criteria. The enhanced discovery service 310 returns a response 345 to the UPnP control point, with the response 345 including pointers to any network devices that meet the criteria, such as a pointer to UPnP network device 305.

The UPnP control point 315 may subscribe to an event of the UPnP network device 310. After some period of time, the UPnP network device may separate abruptly from the network without providing any message regarding the exit from the network. To maintain state information, the enhanced discover service may periodically request renewal of subscriptions to events of network devices. For example, the enhanced discovery service 310 sends a subscription renewal 350 to the UPnP network device 305. In this example, the UPnP network device 305 has left the network without warning, such as in the case of a wireless device that has dropped out of communication with the network, and thus the device has not sent a “bye-bye” message to subscribers. In this case, there is no response 355, thereby informing the enhanced discovery service 310 that the UPnP network device 305 is no longer available. The enhanced discovery service 310 then sends a proxy bye-bye signal 360 to the UPnP control point to inform the control point of the loss of the UPnP network device 305.

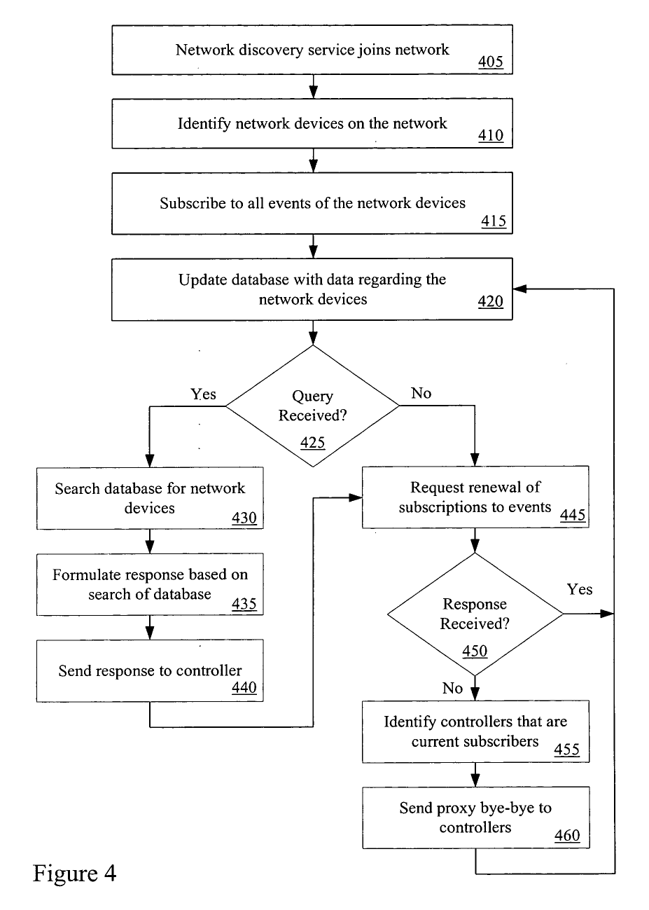

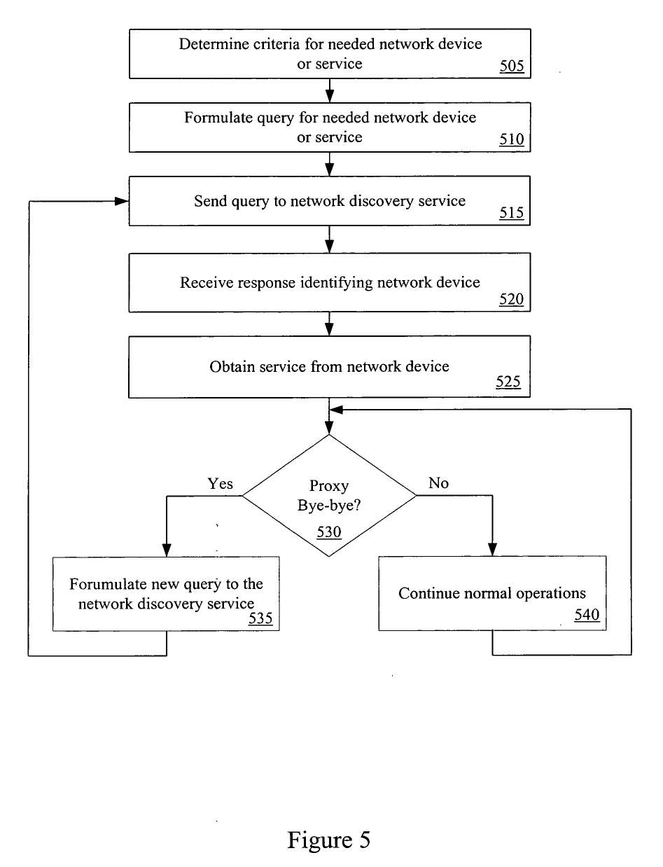

FIG. 4 is a flowchart to illustrate an embodiment of a process for maintaining state information for controllable devices on a network. FIG. 5 is a flowchart to illustrate an embodiment of a process for discovering a network device using a network discovery service. FIGS. 4 and 5 do not contain all processes that might be followed in an embodiment of the invention, and the processes involved are shown in a simplified manner for purposes of explanation. In this illustration, a network discovery device joins a network 405. The network discovery service identifies all of the network devices on the network 410. The network discovery service may discover all such network devices, the network devices may register with the network discovery service, or there may be a combination of both processes. The discovery service further subscribes to all of the events of each of the discovered devices 415. The discovery service updates a database containing information regarding the network devices and services offered by such devices 420.

If a query regarding network devices or services that meet certain criteria is received from a controller 425, the discovery service searches the database for network devices that meet the criteria or provide services meeting the criteria 430. The discovery service then formulates a response based at least in part on the results of the search 435 and returns the response to the controller 440.

A discovery service may also periodically request renewals of subscriptions to events of network devices 445. The discovery service then determines whether any network device fails to respond to a renewal request 450, indicating that the network device has left the network without warning. If so, the discovery service identifies any controllers that are current subscribers to the network device 455 and sends proxy bye-bye messages to such controllers 460 to notify the controllers that the network device is no longer available.

In FIG. 5, a controller determines criteria required for a network device or a service provided by the network device 505. The controller then formulates a query to a network discovery service 510, the query including such criteria. The controller sends the query to the network discovery service 515. The controller receives a response from the network discovery service 520, which may identify one or more network devices meeting the criteria. The controller then may then obtain a service from an identified network device 525.

During operation, the controller may receive a proxy bye-bye message from the network discovery service 530. The proxy message notifies the controller that the network device is no longer available. Using such information, the controller may form a new query to the network discovery service 530 and provide such query to the network discovery service 515. Otherwise, the controller may continue normal operations 540.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention may include various processes. The processes of the present invention may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Portions of the present invention may be provided as a computer program product, which may include a machine-readable medium having stored thereon instructions, which may be used to program a computer (or other electronic devices) to perform a process according to the present invention. The machine-readable medium may include, but is not limited to, floppy diskettes, optical disks, CD-ROMs (compact disk read-only memory), and magneto-optical disks, ROMs (read-only memory), RAMs (random access memory), EPROMs (erasable programmable read-only memory), EEPROMs (electrically-erasable programmable read-only memory), magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below.

It should also be appreciated that reference throughout this specification to “one embodiment” or “an embodiment” means that a particular feature may be included in the practice of the invention. Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

What is claimed is:

1. A method comprising:
identifying a network device on a network;
storing data regarding a state of the network device;
receiving a request from a controller, the query requesting one or more network devices or services provided by network devices that meet a criterion; and
searching the data for one or more network devices that meet the criterion.

2. The method of claim 1, further comprising sending a response to the controller, the response identifying the network device.

3. The method of claim 1, further comprising subscribing to any events of the network device.

4. The method of claim 3, further comprising sending a subscription renewal to the network device.

5. The method of claim 4, further comprising sending a proxy message to the controller indicating that the network device is unavailable if a response is not received to the subscription renewal.

6. The method of claim 1, wherein identifying the network device comprises discovering the network device on the network.

7. The method of claim 1, wherein identifying the network device comprises receiving a registration from the network device.

8. A network discovery service comprising:
a network interface to connect with a network, the network device to receive a query from a controller over the network interface, the query including one or more criteria for a network device or a service to be provided by a network device; and
a directory, the directory to store data regarding network devices identified on the network; and
a query engine to process the query, the processing of the query by the query engine to include searching the directory for network devices that match the one or more criteria.

9. The network discovery service of claim 8, wherein the network device is a universal plug and play (UPnP) device.

10. The network discovery service of claim 9, wherein the controller is a UPnP control point.

11. The network discovery service of claim 8, wherein the query is an XML (Extensible Markup language) XPath query.

12. The network discovery service of claim 11, wherein the response is an XML document containing pointers to devices matching the one or more criteria.

13. The network discovery service of claim 8, wherein the network discovery service is to subscribe to events of the identified network devices.

14. The network discovery service of claim 13, wherein the network discovery service is to provide a proxy message upon determining that a network device has left the network.

15. A system comprising:
a network;
a plurality of universal plug and play (UPnP) devices connected to the network;
a UPnP control point connected to the network; and
a discovery service, the discovery service to identify the plurality of UPnP devices connected to the network and to respond to queries from the UPnP control point.

16. The system of claim 15, wherein a query from the UPnP control point includes one or more criteria for a UPnP device or a service provided by a UPnP device.

17. The system of claim 17, wherein a response to a query is a list of the UPnP devices filtered by the criteria of the query.

18. The system of claim 15, wherein the discovery service is subscribed to all events of the identified UPnP devices.

19. The system of claim 18, wherein the discovery service is to periodically request renewal of the subscriptions to the events.

20. The system of claim 19, wherein the discovery service is to send a proxy message to the UPnP control point if a UPnP network device does not respond to a request for renewal of an event subscription.

21. A machine-readable medium having stored thereon data representing sequences of instructions that, when executed by a processor, cause the processor to perform operations comprising:
identifying a network device on a network;
storing data regarding a state of the network device;
receiving a request from a controller, the query requesting one or more network devices or services provided by network devices that meet a criterion; and
searching the data for one or more network devices that meet the criterion.

22. The medium of claim 21, wherein the sequences of instructions further comprise instructions that cause the processor to perform operations comprising sending a response to the controller, the response identifying the network device.

23. The medium of claim 21, wherein the sequences of instructions further comprise instructions that cause the processor to perform operations comprising subscribing to any events of the network device.

24. The medium of claim 23, wherein the sequences of instructions further comprise instructions that cause the processor to perform operations comprising sending a subscription renewal to the network device.

25. The medium of claim 24, wherein the sequences of instructions further comprise instructions that cause the processor to perform operations comprising sending a proxy message to the controller indicating that the network device is unavailable if a response is not received to the subscription renewal.

26. The medium of claim 21, wherein identifying the network device comprises discovering the network device on the network.

27. The medium of claim 21, wherein identifying the network device comprises receiving a registration from the network device.
